(19) United States
(12) Patent Application Publication
(10) Pub. No.: US 2013/0270350 A1
(43) Pub. Date: Oct. 17, 2013

(54) Programmable Water Heater Thermostat Controller

(71) Applicant: Narayanan M. Subramanian, Marietta, GA (US)

(72) Inventor: Narayanan M. Subramanian, Marietta, GA (US)

(73) Assignee: INVENTION DYNAMICS, LLC, Marietta, GA (US)

(21) Appl. No.: 13/443,966

(22) Filed: Apr. 11, 2012

(51) Int. Cl. G05D 23/19

(52) U.S. Cl. 236/20 R

(57) ABSTRACT

A programmable water heater thermostat controller that attaches over the temperature control unit of existing gas or electric water heaters. The user programs the temperature of water required at different times of the day. A microcontroller then compares the current temperature setting against desired setting every minute and rotates the temperature control knob accordingly using a geared motor. If vacation mode is chosen, then the microcontroller skips program times and keeps the temperature control knob at the lowest temperature setting. If ‘temperature hold’ mode is chosen, then the microcontroller skips program times and keeps the temperature control knob at the same position it was in when the unit was placed in ‘temperature hold’ mode.

### REFERENCE CITED

U.S. Pat. No. 8,022,647-Sep. 20, 2011-Davis et al.
U.S. Pat. No. 7,380,522-Jun. 3, 2008-Anthony Krell et al.
U.S. Pat. No. 6,920,843-Jul. 26, 2005-William E. Wilson
U.S. Pat. No. 6,560,409-May 6, 2003-Henry E. Troost IV
U.S. Pat. No. 6,375,087-Apr. 23, 2002-Paul Reuben Day et al
20070051819-Mar. 8, 2007-Nissim Isaacson

### PRIORITY CLAIM

This patent application claims the benefit of non-provisional application Ser. No. 12/877,156 which was filed on Sep. 8, 2010. This application also claims the benefit of provisional patent application No. 61/241,480 which was filed on Sep. 11, 2009.

### FIELD OF INVENTION

The present invention relates to controlling the thermostat on both electric and gas powered water heaters based on user programmed settings.

### BACKGROUND OF INVENTION

Water heaters come with a thermostat to adjust the temperature of water. When the set temperature is reached, the burner in gas powered water heater or the electric coil in electric water heater is turned off. When the temperature drops below the set temperature, the water heater is turned on again. This process is repeated all the time. The user sets the temperature high enough to get hot water during periods of peak usage even on the coldest day of the year. This temperature is maintained during the day as well as night when there is not much need for hot water. People seldom change the setting of the thermostat. Hence the high temperature is maintained even during summer. This results in wastage of fuel. This also shortens the life of the water heater. There is a need for a programmable thermostat that can be programmed to heat water in the morning to the required high temperature, then turn down the thermostat during daytime when there is no one in the house to use hot water, turn it up again to a moderate temperature in the evening for dinner time usage and turn it down for the night. Since there are already millions of water heaters in use, the programmable thermostat should be easy to install on existing water heaters.

In U.S. Pat. No. 6,920,843, William Wilson uses a solenoid in the gas supply line to interrupt supply of gas. The main drawback of this design is that the user will have to get the unit installed by a licensed plumber. Homeowners are reluctant to do this since it adds cost and it may void the warranty on the water heater. In U.S. Pat. Nos. 7,380,522 and 6,375,087, the system has to be built in by the manufacturer. It cannot be attached to the millions of water heaters already in use. In U.S. Pat. No. 8,022,647, Davis et al disclose a programmable gas water heater controller. This also has a few drawbacks. To attach this unit to the gas water heater, the user will have to pry and remove the control knob from the gas water heater. Research has shown that people are reluctant to do this since they are not sure if removing the knob will break something inside, resulting in gas leakage. Also, the manufacturer recommends a certain temperature setting to assure sufficient hot water supply for a normal size family. But if the usage is more than normal during certain times of the day, the user might want to set the temperature higher. This is not possible with Davis et al.'s invention since the manufacturer of this programmable device sets the high and low temperatures. The user does not have control to set different water temperatures at different times of the day.

### SUMMARY OF INVENTION

The primary objective of the present invention is to conserve energy by way of a programmable controller that can vary the temperature setting at different times of the day.

Another objective of the present invention is to make it easy for anyone to attach the unit to an existing water heater without the need to call a plumber.

A third objective is to make the unit cost effective for the consumers to buy and use it.

The foregoing objectives are attained by having a programmable microcontroller vary the temperature setting by turning the temperature control knob based on user preprogrammed temperature settings at user preprogrammed times of the day.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is the prior art of a storage type water heater with a temperature control unit.

FIG. 2 is a perspective view of the temperature control knob drive mechanism of the preferred embodiment of the programmable water heater thermostat controller and their relative order of position for attachment to the temperature control knob on the water heater.

FIG. 3 is a block diagram of the electronic control unit used to control the rotation of the temperature control knob drive mechanism.

FIG. 4 is a schematic circuit diagram to control the direction of rotation of a geared motor using two single pole double throw relays.

FIG. 5 is the block diagram of the remote user interface.

FIG. 6 is a flowchart of the decision process used by the microcontroller to rotate the temperature control knob at different times of the day. It also shows the logic used to program the time and temperature information by the user. Vacation mode and temperature hold mode decision logic is also illustrated.

FIG. 7 shows a flowchart of the decision process used by the first transceiver means.

FIG. 8 is a perspective view of the temperature control knob drive mechanism of a second preferred embodiment of the programmable water heater thermostat controller and their relative order of position for attachment to the temperature control knob on the water heater

### DETAILED DESCRIPTION OF THE INVENTION

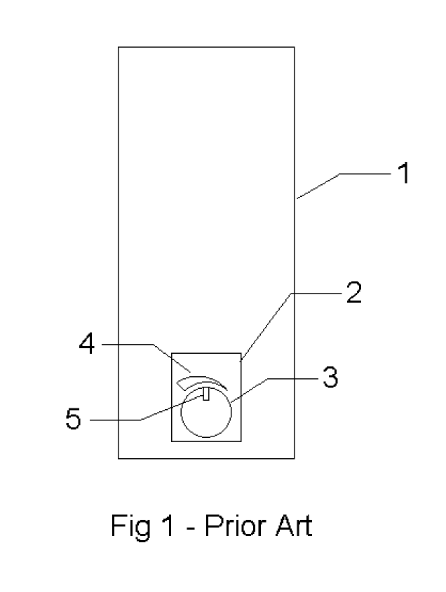

FIG. 1 is the prior art of a storage type water heater, 1. Storage type water heater, 1, has a temperature control unit 2, to control the temperature of water heated. Temperature control unit 2 has a temperature control knob 3 that is turned to set the desired temperature for hot water. Arc 4 above the temperature control knob shows the direction the temperature control knob should be turned to increase water temperature. In this illustration, the temperature control knob should be turned in a counter clockwise direction to increase the temperature. The present position indicator, 5, on temperature control knob 3, shows the present temperature setting with respect to arc 4.

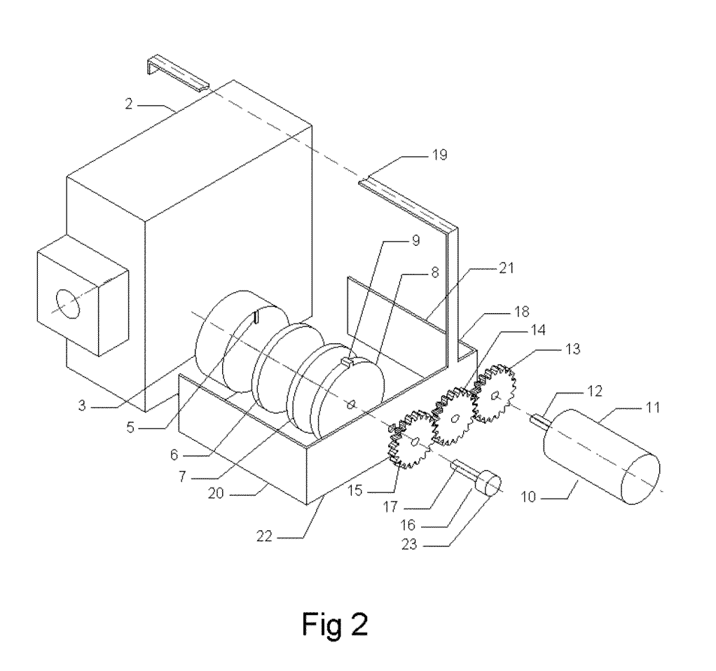

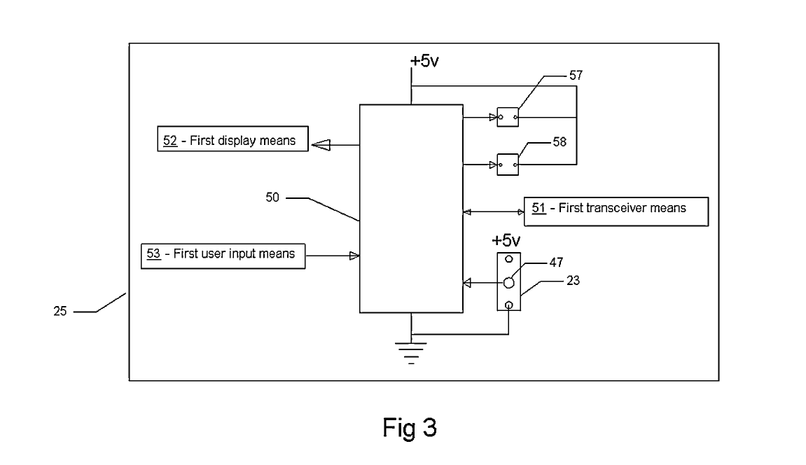

FIG. 2 shows the perspective view of the temperature control knob drive mechanism of the preferred embodiment of the programmable water heater thermostat controller and their relative order of position for attachment to the temperature control knob, 3, on storage type water heater, 1. Henceforth the programmable water heater thermostat controller will be referred to as the controller device. The controller device consists of a mounting harness, 18, a drive means, 10, a present position sensing means, 16 and a driver means 8. It also has attachment means to communicate with the temperature control knob and an electronic control unit, 25, shown in FIG. 3, to control the operation. These will be explained later. The present position sensing means can be an optical sensor where a slotted rotating disk interrupts light and the number of pulses or interruptions provides a means for determining the present position of the temperature control knob. Or, it can be a Hall Effect sensor where the passage of a magnet across the face of the hall effect sensor gives a pulse. For this preferred embodiment, the present position sensing means used is a potentiometer 23 with a shaft 17. Since the resistance of the potentiometer varies when shaft 17 is rotated, it is a good candidate as a present position sensor.

Mounting harness 18 consists of a hanger, 19, a front support, 22 and two side arms 20 and 21. The distance between the two side arms is substantially equal to the width of temperature control unit 2. Hanger, 19, is shaped such that when the mounting harness is placed properly on the temperature control unit, the hanger will rest on the top surface of temperature control unit 2 and hang. Side arms 20 and 21 will go on either side of the temperature control unit. Drive means, 10, train of gears comprising of gears 13, 14 and 15, potentiometer, 23, and electronic control unit, 25, are attached to said front support, 22 of the mounting harness. The drive means has a geared motor, 11 with a shaft, 12. Shaft 12 passes through gear 13. Gears 13, 14 and 15 are in mechanical communication with each other. Shaft 17 passes through gear 15, front support 22, and driver means, 8. Thus the drive means is in mechanical communication with the driver means. The axes of rotation of temperature control knob 3, driver means 8, gear 15 and shaft 17 are substantially the same. The driver means is a rigid disk, preferably circular in shape, with a present position marker, 9, on its circumference. This present position marker is comparable to present position indicator 5 in FIG. 1. In this preferred embodiment of the invention, an adhesive backed hook and loop fastener is used as the attachment means. This type of attachment means may also be referred to as a friction drive attachment. Adhesive backed hook, 7, of the hook and loop fastener is securely attached to that face of the driver means which is away from gear 15. Adhesive backed loop, 6, of the hook and loop fastener is attached securely to the face of temperature control knob, 3. The hook and the loop may be interchanged between the driver means and the temperature control knob. When the hook and the loop of the fastener are in physical communication with each other, and the driver means is rotated by the geared motor, the temperature control knob, 3, is turned, thereby varying the water temperature setting. The shaft of the potentiometer also is turned in the process, thereby providing the temperature control knob's present position information. The electrical terminals on the geared motor are connected to contacts on relays 57 and 58 on the electronic control unit as shown in FIG. 3.

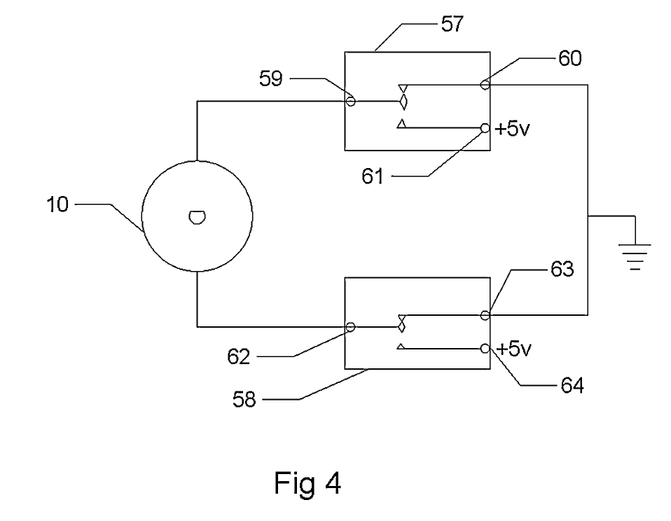

Referring to FIG. 3, the electronic control unit, 25, consists of a microcontroller 50 that is electrically connected to a first user input means 53. The first user input means can be a keyboard, a touch screen or a plurality of switches. The user can, through the first user input means, communicate user desired time and corresponding user desired temperature control knob position information to the microcontroller. The microcontroller displays this information on a first display means, 52. The microcontroller also accepts data on voltage present on the center tap terminal 47 of potentiometer 23. The voltage between ground and the center tap terminal varies proportional to the rotational position of temperature control knob 3. This voltage is converted to a proportional digital value by the analog to digital converter on the microcontroller. The microcontroller is also connected to relay coils in relays 57 and 58. These relays are, at a minimum, of the single pole double throw (SPDT) type. The relay contacts are connected to the electrical terminals of drive means 10 as shown in FIG. 4. Thus by energizing and de-energizing the relays, the microcontroller controls the drive means and through it, the temperature control knob. The microcontroller communicates with a remote user interface via a first transceiver means, 51 to accept or display information on a remote user interface.

FIG. 4 is a schematic diagram of the relay contacts connection with the drive means electrical terminals. Each relay has two fixed contacts and one moveable contact. Moveable contacts, 59 and 62 are connected to the electrical terminals of drive means 10. Fixed contacts 60 and 63, which are normally closed, are connected to ground while fixed contacts 61 and 64, which are normally open, are connected to positive voltage, which is +5 volts in this case.

When relays 57 and 58 are de-energized, the electrical terminals of drive means are connected to ground. Hence shaft 12 of drive means 10 will not turn. When only relay 57 is energized by the microcontroller, drive means terminal connected to moveable contact 59 is at +5 volts with respect to terminal connected to contact 62. Hence the drive means is energized and the shaft turns in one direction. Let us assume it to be clockwise direction. When only relay 58 is energized by the microcontroller, drive means terminal connected to moveable contact 62 is at +5 volts with respect to terminal connected to contact 59. Hence the drive means is energized but with the polarity of the terminals reversed. Hence the shaft of drive means 10 turns in the counter clockwise direction. Thus the microcontroller controls the direction of rotation of the drive means and thereby, the direction of rotation of the temperature control knob.

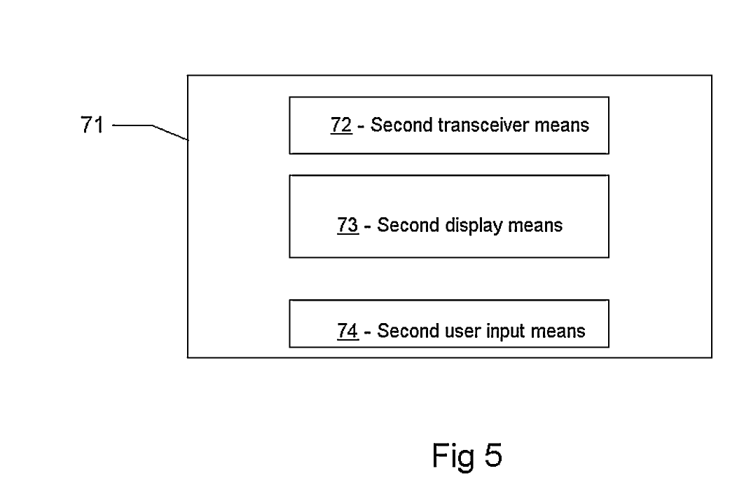

FIG. 5 is a block diagram of the remote user interface, 71. It consists of a second user input means, 74, a second display means, 73, and a second transceiver means, 72. The second user input means can be a keyboard, a touch screen or a plurality of switches. The second transceiver means is designed to communicate seamlessly with the first transceiver means. Thus, to change the user desired time/temperature program information, the user need not go to the basement where the water heater is generally kept. They can use the remote user interface from any location in the house to change the time and temperature settings programmed.

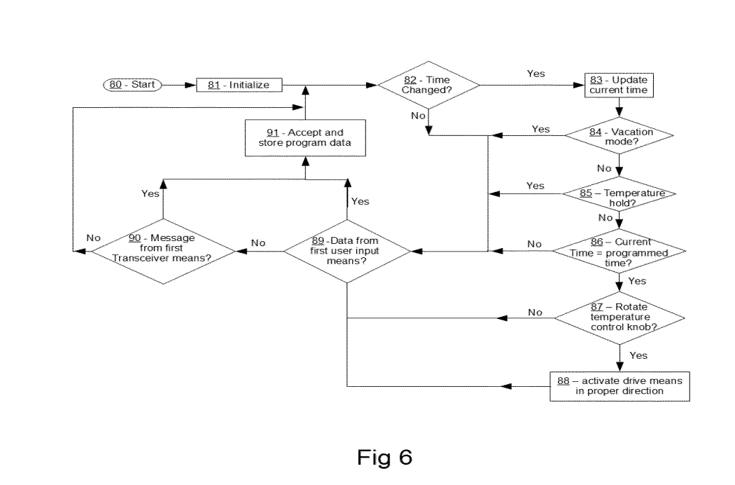

FIG. 6 shows the decision logic used by the microcontroller to turn the temperature control knob based on current time and the user programmed time/desired temperature control knob position data. It also shows the decision logic used when the ‘vacation’ mode or the ‘temperature hold’ mode is selected by the user. The microcontroller keeps checking the first user input means and the first transceiver means to see if any user data is coming to it to process. If there is any user input, it goes into programming mode to accept and store user desired time and corresponding user desired temperature control knob position data.

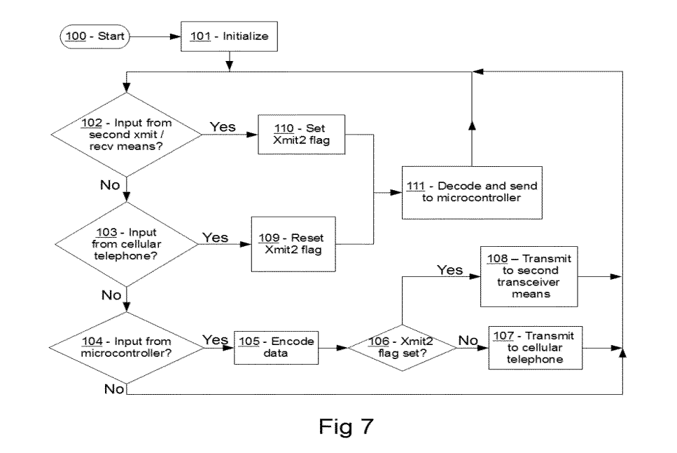

FIG. 7 shows the decision logic used by the first transceiver means to communicate a plurality of user desired time and corresponding user desired temperature control knob position data with a plurality of sources it is configured to communicate with, such as cell phones and remote user interface.

The user attaches the preferred embodiment of the present invention to the temperature control unit 2, by sliding side arms 20 and 21 on the sides of temperature control unit 2 and placing the hanger, 19, over the top surface of temperature control unit 2. When this is done, the hook on the face of rigid driver means will mate with the loop on the surface of temperature control knob 3. When the drive means is actuated by the microcontroller through one of the two relays, the geared motor, through the train of gears 13, 14 and 15, will turn driver means, 8, and shaft 17 of potentiometer, 23. The driver means, which is in physical communication with the temperature control knob because of the hook and loop fastener, will turn the temperature control knob, 3. The microcontroller gets continuous information from the potentiometer about the present position of the temperature control knob. Once the present position of the temperature control knob matches the user desired temperature control knob value, the microcontroller de-energizes the relay and stops the geared motor from rotating. This process is repeated every time the programmed value for the position of the temperature control knob at that programmed time varies from the present position of the temperature control knob.

Every minute, the microcontroller checks to see if the controller device is placed in vacation mode or temperature hold mode.

If the user places the controller device in vacation mode, the microcontroller energizes the appropriate relay to turn the temperature control knob to lower the temperature to vacation setting. After this, the programmed, user desired temperature control knob settings are ignored till the user, on return from vacation, places the controller device in normal operation mode. If the user places the controller device in temperature hold mode, the microcontroller ignores future, programmed, user desired temperature control knob settings and maintains the temperature control knob at that same temperature it was in when the user placed the controller device in temperature hold mode. For normal operation to resume, the user must place the controller device in normal operation mode again.

In normal operation mode, the microcontroller compares the current time against a plurality of stored, user desired times. If there is a match, it reads the corresponding stored, user desired temperature control knob position value. Then it compares this user desired temperature control knob position value against the digital value for the present position of temperature control knob 3 to determine whether the temperature control knob should be turned or not. Based on this evaluation, if needed, it energizes the appropriate relay to turn shaft 12 of drive means in the proper direction. While the relay is energizing the drive means, the microcontroller continually reads the potentiometer center tap voltage and compares it with the user desired temperature control knob position value. Once the two values match, the microcontroller de-energizes the relay to stop the drive means.

The microcontroller also checks continually for input from the first transceiver means and the first user input means. If an input is present from either source, the microcontroller accepts the input and processes it. If the input comes from the first user input means, then the display result is sent to the first display means. If the input comes from the first transceiver means, then the display result is sent to the first transceiver means.

The first transceiver means continually checks for wireless input from a plurality of devices with which it is configured to communicate. Some examples of such devices are the remote user interface and the cellular telephone. The user may change the program from a different part of the house using the remote user interface. Or the user might realize, while on the road that he has forgotten to set the controller device in vacation mode. In that instance he might use the cellular telephone to change the mode of operation. When the first transceiver means receives input wirelessly, it knows the source of the input. It decodes the input and presents it to the microcontroller. When the microcontroller responds with display information, the first transceiver means encodes the information appropriately and transmits it wirelessly to the device from which it received the input data originally.

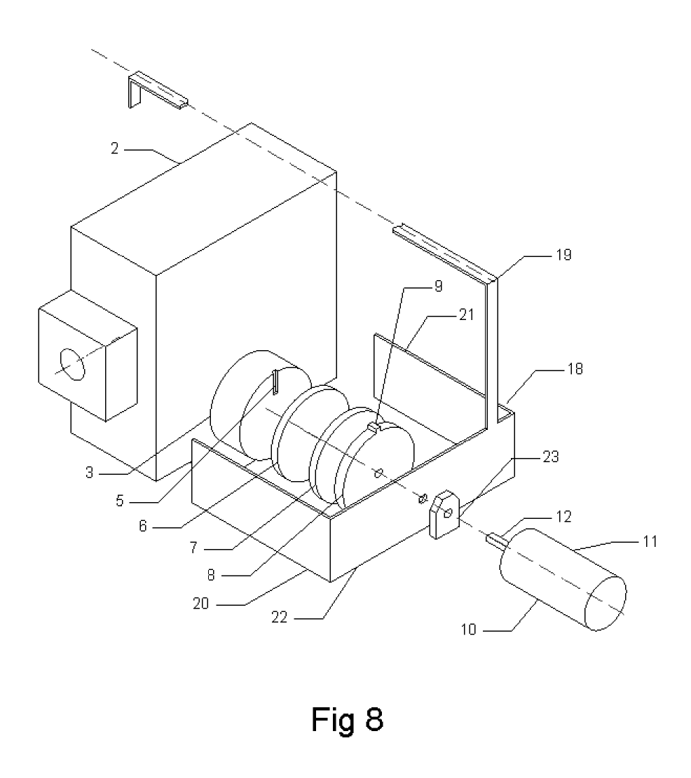

FIG. 8 is a perspective view of the temperature control knob drive mechanism of a second preferred embodiment of the programmable water heater thermostat controller and their relative order of position for attachment to the temperature control knob on the water heater. In this embodiment, a potentiometer has a hole in the center instead of a shaft. Hence train of gears 13, 14 and 15 of the first preferred embodiment are not used here. Instead shaft 12 of the drive means is used to directly turn the potentiometer center tap and the driver means, 8. Otherwise, the operation of this second preferred embodiment of the present invention is the same as the first preferred embodiment of the present invention.

What is claimed is:

1. A programmable water heater thermostat controller for controlling a temperature control knob on a water heater comprising:
a) a driver means having a present position marker, in physical communication with said temperature control knob of said water heater, wherein said temperature control knob is further characterized as having a present position indicator;
b) a position sensing means coupled to said driver means and operative to detect said present position information of said temperature control knob;
c) a drive means in mechanical communication with said driver means, further characterized in that actuation of said drive means causes movement of said temperature control knob;
d) an electronic control means configured to receive said present position information from said position sensing means and configured to actuate said drive means; the electronic control means further comprising:
i. a microcontroller;
ii. a first transceiver means configured to exchange a plurality of user desired time and corresponding user desired temperature control knob position data with a plurality of external transceiver means;
iii. a first display means configured to receive display data from said microcontroller and display it to user;
iv. a first user input means configured to be operable by users to communicate user desired time and corresponding user desired temperature control knob position data; and,
e) a mounting harness enclosing at least a portion of said drive means, said position sensing means, and said electronic control means;

2. The programmable water heater thermostat controller of claim 1, wherein said drive means is a geared motor with a shaft.

3. The programmable water heater thermostat controller of claim 1, wherein said driver means has its rotational axis substantially the same as the rotational axis of temperature control knob.

4. The programmable water heater thermostat controller of claim 1, wherein said physical communication between said driver means and said temperature control knob is achieved using hook and loop fasteners.

5. The programmable water heater thermostat controller of claim 1, wherein said drive means is in mechanical communication with said driver means using a plurality of gears.

6. The programmable water heater thermostat controller of claim 1, wherein said position sensing means is a potentiometer.

7. The programmable water heater thermostat controller of claim 1, wherein said position sensing means is an optical sensor.

8. The programmable water heater thermostat controller of claim 1, wherein said microcontroller is configured to:
a) keep track of current time;
b) accept and store a plurality of said user desired time and corresponding user desired temperature control knob position data from said first transceiver means;
c) accept and store a plurality of said user desired time and corresponding user desired temperature control knob position data from said first user input means;
d) compare, when current time substantially equals stored user desired time, the corresponding stored, user desired temperature control knob position data with temperature control knob present position data from said position sensing means and determine direction of rotation of said drive means to reach said stored, user desired temperature control knob position;
e) activate said drive means in determined direction;
f) deactivate said drive means when said stored, user desired temperature control knob position data substantially matches temperature control knob present position data from said position sensing means.

9. The programmable water heater thermostat controller of claim 8, wherein said microcontroller is further configured to:
a) accept vacation as a mode selection;
b) determine direction of rotation of said drive means to rotate temperature control knob to lowest temperature setting available when said vacation mode selected;
c) activate said drive means in determined direction;
d) deactivate said drive means when temperature control knob present position data from said position sensing means indicates lowest temperature setting reached;
e) deactivate stored, user desired temperature control knob position comparison till user input cancels said vacation mode selection.

10. The programmable water heater thermostat controller of claim 8, wherein said microcontroller is further configured to:
a) accept temperature hold as a mode selection;
b) deactivate stored, user desired temperature control knob position comparison till user input cancels said temperature hold mode selection.

11. The programmable water heater thermostat controller of claim 1, wherein said first transceiver means is configured to:
a) decode received data from said plurality of external transceiver means for user input data;
b) make available said decoded user input data to said microcontroller;
c) accept display data from said microcontroller;
d) encode said display data for said plurality of external transceiver means to accept;
e) transmit said encoded display data to said plurality of external transceiver means.

12. The programmable water heater thermostat controller of claim 1, wherein said first user input means is a keyboard.

13. The programmable water heater thermostat controller of claim 1 wherein said first user input means is a plurality of switches.

14. The programmable water heater thermostat controller of claim 1 wherein said first user input means is a touch screen.

15. The programmable water heater thermostat controller of claim 1, wherein said external transceiver means is a cellular telephone.

16. The programmable water heater thermostat controller of claim 1, wherein said external transceiver means is a remote user interface comprising of a second user input means, a second display means and a second transceiver means; said second transceiver means configured to communicate seamlessly with said first transceiver means, said second user input means and said second display means.

17. The programmable water heater thermostat controller of claim 16, wherein said second user input means is a keyboard.

18. The programmable water heater thermostat controller of claim 16, wherein said second user input means is a plurality of switches.

19. The programmable water heater thermostat controller of claim 16, wherein said second user input means is a touch screen.

20. The programmable water heater thermostat controller of claim 1, wherein said mounting harness comprises of a front support, two side arms and a hanger; said hanger configured to hang from top of temperature control unit; said side arms configured to be in physical communication with sides of temperature control unit.
